(19) United States
(12) Patent Application Publication
(10) Pub. No.: US 2015/0174987 A1
(43) Pub. Date: Jun. 25, 2015

(54) AIR CONDITIONER FOR VEHICLES

(71) Applicant: Hyundai Motor Company, Seoul (KR)

(72) Inventor: Yoon Hyung LEE, Suwon-si (KR)

(73) Assignee: Hyundai Motor Company, Seoul (KR)

(21) Appl. No.: 14/314,898

(22) Filed: Jun. 25, 2014

(30) Foreign Application Priority Data
Dec. 23, 2013 (KR) 10-2013-0161446

(51) Int. Cl. B60H 1/00

(52) U.S. Cl. CPC B60H 1/00671

(57) ABSTRACT

An air conditioner for a vehicle may has mode doors that are installed on an air conditioning case and have a vent door and a floor door that are connected to each other by a connecting link, and cools, heats, and ventilates an interior room through various operation modes, and a sub door, which distributes supplied air while being rotated about a separate drive shaft, is installed between the vent door and the floor door.

### CROSS-REFERENCE TO RELATED APPLICATION

The present application claims priority to Korean Patent Application No. 10-2013-0161446 filed on Dec. 23, 2013, the entire contents of which is incorporated herein for all purposes by this reference.

### BACKGROUND OF THE INVENTION

1. Field of the Invention

The present invention relates to an air conditioner for a vehicle, and more particularly, to an air conditioner for a vehicle in which a sub door is installed between a vent door and a floor door of the air conditioner.

2. Description of Related Art

In general, an air conditioner (HVAC, heating, ventilation, air conditioning) for a vehicle cools, heats, and ventilates an interior room while performing operation modes such as a vent mode, a defrost mode, a floor mode, a mix mode, and a bi-level mode depending on rotation of a mode door that is installed in an air conditioning case.

The mode door of the air conditioner includes a vent door and a floor door.

That is, the vent door controls a flow of air, which is discharged to a window side outlet and a face side outlet, by adjusting an opening degree thereof. In this case, the operation modes of the air conditioner are the defrost mode and the vent mode.

Further, the floor door controls a flow of air, which is discharged to a floor outlet, by adjusting an opening degree thereof. In this case, the operation mode of the air conditioner is the floor mode.

In addition, the vent door and the floor door may be simultaneously operated to simultaneously discharge air to the window side outlet and the floor outlet. In this case, the operation mode of the air conditioner is the mix mode.

In addition, the vent door and the floor door may be simultaneously operated to simultaneously discharge air to the face side outlet and the floor outlet. In this case, the operation mode of the air conditioner is the bi-level mode.

The mode doors, which perform the aforementioned functions, may be manually operated, or may be automatically controlled by an automatic temperature adjusting device.

However, according to the mode doors of the air conditioner for a vehicle, when the vent door is operated, the vent door directly receives wind pressure while being rotated, and as a result, there are drawbacks in that a rapid increase in effort occurs, and thereby, operational uniformity deteriorates.

Particularly, when the air conditioner is operated, the vent door is in a state in which the vent door floats in the air, and as a result, there are drawbacks in that the vent door greatly vibrates because an irregular pressure fluctuation occurs at the periphery of the vent door, such that noise occurs.

In addition, there are drawbacks in that when the floor door is operated, an inflection portion is formed on a cam trajectory due to a great operational angle of the door, and thereby, a mechanical unsmoothness problem occurs.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing an air conditioner for a vehicle, which has a sub door that is independently installed between a vent door and a floor door that are mode doors, and operated in conjunction with the vent door and the floor door.

In an aspect of the present invention, an air conditioner for a vehicle, which may have mode doors that are installed on an air conditioning case and may have a vent door and a floor door that are connected to each other by a connecting link, and cools, heats, and ventilates an interior room through various operation modes, wherein a sub door, which distributes supplied air while being rotated about a separate drive shaft, is installed between the vent door and the floor door.

The drive shaft is rotatably connected to the connecting link, and the sub door is operated in conjunction with the vent door and the floor door.

The sub door is rotated so as to correspond to an operation mode of the mode door.

The sub door may include the drive shaft rotatably which is connected to the connecting link, an upper vane which is provided on an outer circumferential surface of the drive shaft, and a lower vane which is provided on an outer circumferential surface of the drive shaft and corresponds to the upper vane.

The lower vane is formed to be inclined toward the floor door.

The drive shaft is connected to a floor link which connects a cam of the connecting link with the floor door.

When the lower vane is rotated, the lower vane partially overlaps a region within which the floor door is rotated.

In another aspect of the present invention, an air conditioner for a vehicle, which may have mode doors that are installed on an air conditioning case and may have a vent door and a floor door that are connected to each other by a connecting link, and cools, heats, and ventilates an interior room through various operation modes, may include a sub door which is installed between the vent door and the floor door, and distributes supplied air while being rotated about a drive shaft, wherein the drive shaft is independently connected to the connecting link, and the sub door is operated in conjunction with the vent door and the floor door, and rotated at a predetermined angle while corresponding to an operation mode of the mode door.

The sub door may include the drive shaft which is rotatably connected to the connecting link, an upper vane which is provided on an outer circumferential surface of the drive shaft, and a lower vane which is provided on an outer circumferential surface of the drive shaft and corresponds to the upper vane.

The lower vane is formed to be inclined toward the floor door.

The drive shaft is connected to a floor link which connects a cam of the connecting link with the floor door.

When the lower vane is rotated, the lower vane partially overlaps a region within which the floor door is rotated.

According to the exemplary embodiment of the present invention, the sub door, which is operated in conjunction with the vent door and the floor door, is independently installed between the vent door and the floor door, thereby distributing wind pressure that is directly applied to the vent door, relieving a rapid increase in effort, and securing uniformity when operating the vent door.

In addition, according to the exemplary embodiment of the present invention, it is possible to distribute an air flow using the sub door, thereby reducing an irregular pressure fluctuation at the periphery of the vent door, and preventing vibration of the vent door and noise from occurring.

In addition, according to the exemplary embodiment of the present invention, it is possible to reduce an operation angle of the floor door using the sub door, and an inflection portion having a steep slope on a trajectory of the cam, thereby resolving a mechanical unsmoothness problem.

Furthermore, according to the exemplary embodiment of the present invention, it is possible to implement an additional effect in that the sub door, which is accessorily installed, serves as a main door without applying a separate main door such as the vent door and the floor door, thereby reducing costs for development, and manufacturing costs.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a perspective view illustrating an internal configuration of an air conditioner for a vehicle according to an exemplary embodiment of the present invention.

FIG. 2 is a front view illustrating the internal configuration of the air conditioner for a vehicle according to the exemplary embodiment of the present invention.

FIG. 3 is a perspective view illustrating a configuration of a mode door of the air conditioner for a vehicle according to the exemplary embodiment of the present invention.

FIG. 4 is a front view illustrating a state in which the air conditioner for a vehicle according to the exemplary embodiment of the present invention is fully operated.

FIG. 5 is a state view of a vent mode of the air conditioner for a vehicle according to the exemplary embodiment of the present invention.

FIG. 6 is a state view of a defrost mode of the air conditioner for a vehicle according to the exemplary embodiment of the present invention.

FIG. 7 is a state view of a floor mode of the air conditioner for a vehicle according to the exemplary embodiment of the present invention.

FIG. 8 is a state view of a mix mode of the air conditioner for a vehicle according to the exemplary embodiment of the present invention.

FIG. 9 is a state view of a bi-level mode of the air conditioner for a vehicle according to the exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereinafter, an exemplary embodiment of the present invention will be described in detail with reference to the accompanying drawings.

The size and thickness of each component illustrated in the drawings are arbitrarily shown for understanding and ease of description, but the present invention is not limited thereto. Thicknesses of several portions and regions are enlarged for clear expressions.

In addition, a part irrelevant to the description will be omitted to clearly describe the exemplary embodiments of the present invention.

According to an air conditioner 1 for a vehicle according to an exemplary embodiment of the present invention, a sub door 9 is independently installed between a vent door 5 and a floor door 7 which are mode doors 3, and operated in conjunction with the vent door 5 and the floor door 7.

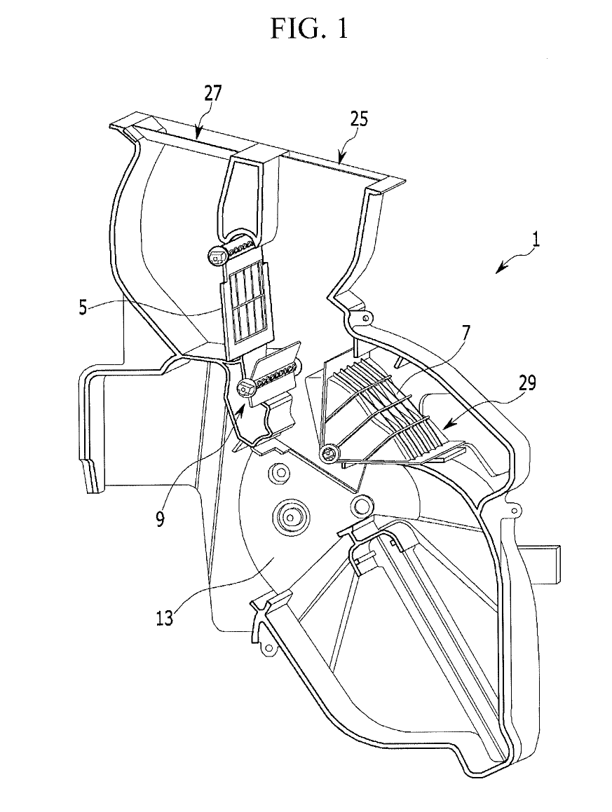

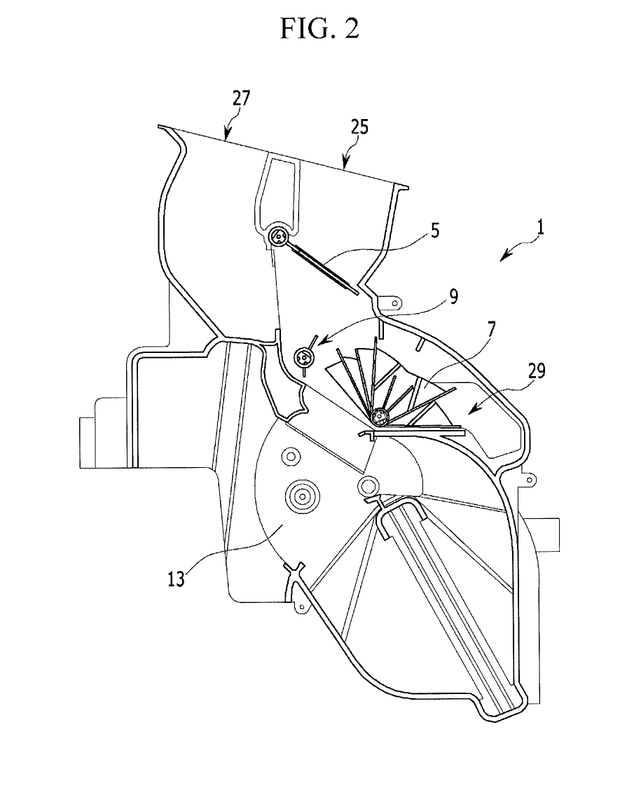

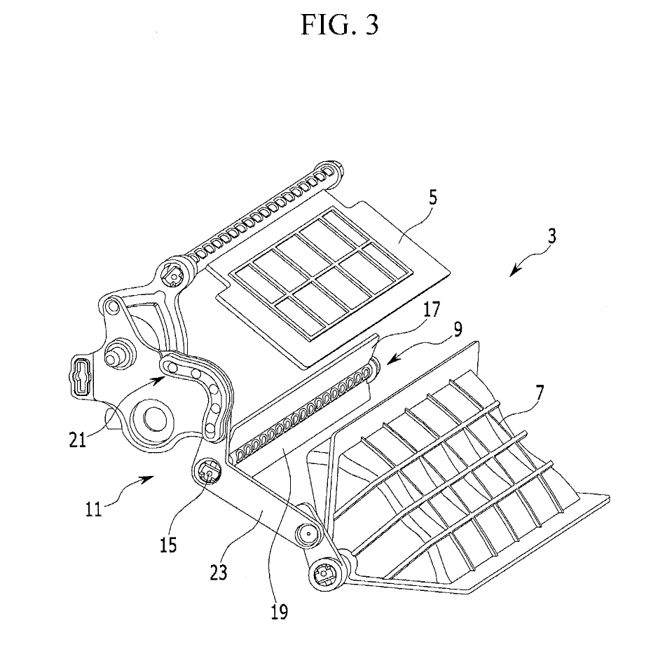

FIG. 1 is a perspective view illustrating an internal configuration of the air conditioner for a vehicle according to the exemplary embodiment of the present invention, FIG. 2 is a front view illustrating the internal configuration of the air conditioner for a vehicle according to the exemplary embodiment of the present invention, and FIG. 3 is a perspective view illustrating a configuration of a mode door of the air conditioner for a vehicle according to the exemplary embodiment of the present invention.

Referring to FIGS. 1 to 3, in the air conditioner 1 for a vehicle according to the exemplary embodiment of the present invention, the mode doors 3, which include the vent door 5 and the floor door 7, are connected to each other by a connecting link 11, and installed on an air conditioning case 13 which forms the air conditioner 1 for a vehicle.

The mode doors 3, which include the vent door 5 and the floor door 7, are rotated while being operated in conjunction with each other through the connecting link 11, and change an operation mode of the air conditioner 1 for a vehicle according to the exemplary embodiment of the present invention.

In general, there are operation modes such as a vent mode, a defrost mode, a floor mode, a mix mode, and a bi-level mode.

Here, because the mode doors 3, which include the vent door 5 and the floor door 7, and the connecting link 11 are configurations publicly known to the corresponding Field of the Invention, a detailed description thereof will be omitted.

The sub door 9, which distributes air flowing into the air conditioning case 13 while being independently rotated about a separate drive shaft 15, is installed between the vent door 5 and the floor door 7.

The drive shaft 15 is connected to the connecting link 11, and thereby, the sub door 9 is operated in conjunction with the vent door 5 and the floor door 7. In addition, the sub door 9 is rotated so as to correspond to an operation mode of the mode door 3.

Hereinafter, a more specific configuration of the sub door 9 will be described.

The sub door 9 includes the drive shaft 15, an upper vane 17, and a lower vane 19.

The drive shaft 15 is connected to the connecting link 11. Here, the drive shaft 15 may be connected to a floor link 23 which connects a cam 21 of the connecting link 11 with the floor door 7.

The upper vane 17 is provided on an outer circumferential surface of the drive shaft 15, and provided vertically toward the vent door 5.

The lower vane 19 is provided on the outer circumferential surface of the drive shaft 15 so as to correspond to the upper vane 17. Here, the lower vane 19 may be formed to be inclined toward the floor door 7.

Further, when the lower vane 19 is rotated, the lower vane 19 may partially overlap a region within which the floor door 7 is rotated.

Accordingly, the lower vane 19 may occupy a region divided by a part of an operation angle of the floor door 7 so as to reduce an inflection portion having a steep slope on a trajectory of the cam 21, thereby resolving mechanical unsmoothness problem that occurs in operation.

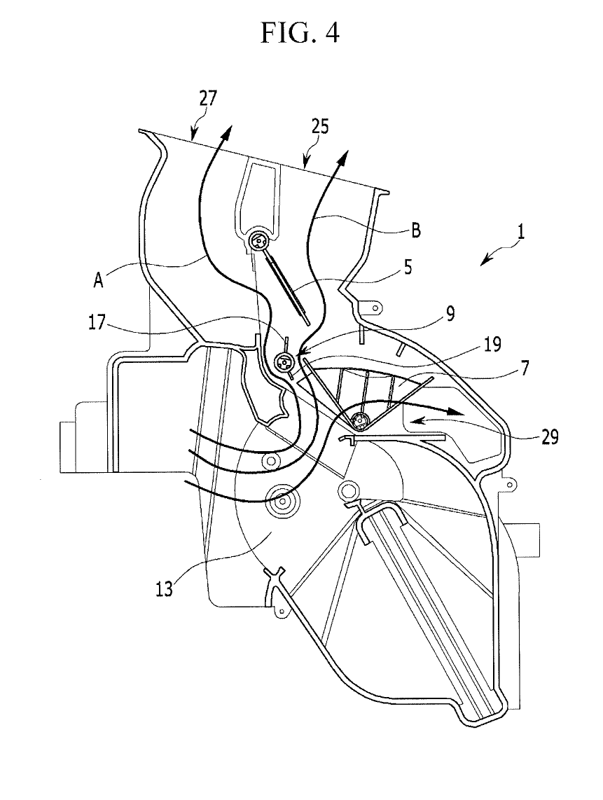

Hereinafter, an operation of the air conditioner 1 for a vehicle, which has the aforementioned configuration, will be described with reference to FIG. 4.

FIG. 4 is a front view illustrating a state in which the air conditioner for a vehicle according to the exemplary embodiment of the present invention is fully operated.

Referring to FIG. 4, the sub door 9 may separate and distribute air, which is supplied toward the vent door 5, and distribute air flow using the upper and lower vanes 17 and 19, as indicated by arrows A and B depicted in the drawing.

Accordingly, wind pressure, which is directly applied to the vent door 5, may be distributed in the arrow directions A and B, thereby relieving a rapid increase in effort, and securing uniformity when operating the vent door 5.

Furthermore, an irregular pressure fluctuation at the periphery of the vent door 5 is reduced by the sub door 9, thereby preventing the vent door 5 from vibrating, and preventing noise from occurring due to the vibration.

Further, the air conditioner 1 for a vehicle according to the exemplary embodiment of the present invention may implement an additional effect in that the sub door 7, which is accessorily installed, serves as a main door without applying a separate main door such as the vent door 5 and the floor door 7.

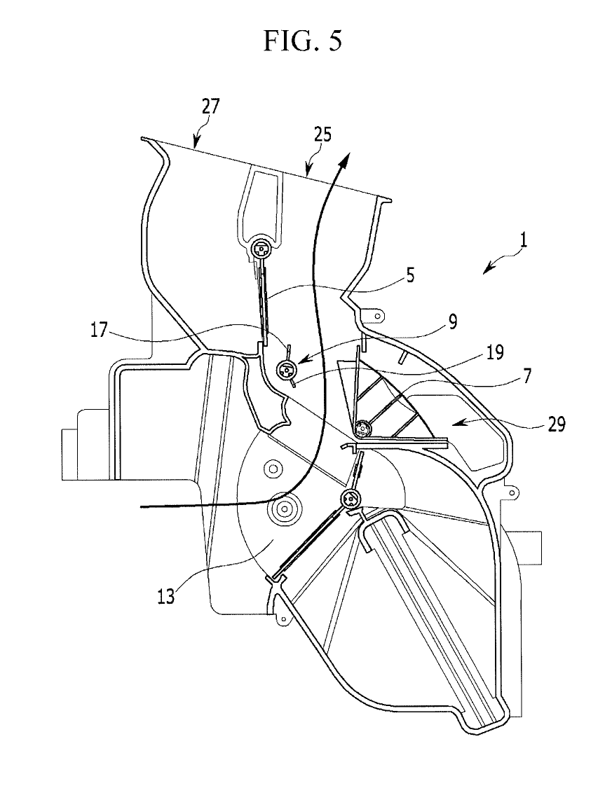

Hereinafter, a state in which the mode doors 3 and the sub door 9, which are installed in the aforementioned air conditioner 1 for a vehicle, are rotated depending on an operation mode of the air conditioner 1 for a vehicle will be described with reference to FIGS. 5 to 9.

FIG. 5 is a state view of a vent mode of the air conditioner for a vehicle according to the exemplary embodiment of the present invention.

Referring to FIG. 5, for an operation in a vent mode, the vent door 5 is rotated toward the sub door 9 so as to open a vent outlet 25, and simultaneously close a defrost outlet 27. Further, the floor door 7 closes a floor outlet 29.

Accordingly, air flowing into the air conditioning case 13 may be discharged to an interior room via the sub door 9 while being guided toward the vent outlet 25.

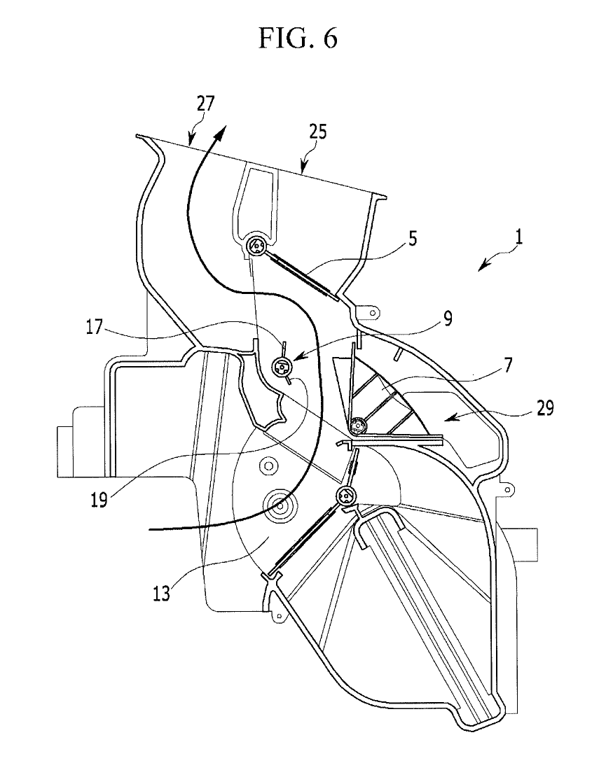

FIG. 6 is a state view of a defrost mode of the air conditioner for a vehicle according to the exemplary embodiment of the present invention.

Referring to FIG. 6, for an operation in a defrost mode, the vent door 5 is rotated toward the vent outlet 25 from a state of the vent mode so as to close the vent outlet 25. At the same time, the defrost outlet 27 is opened.

Accordingly, air flowing into the air conditioning case 13 may be discharged to the interior room via the sub door 9 while being guided toward the defrost outlet 27.

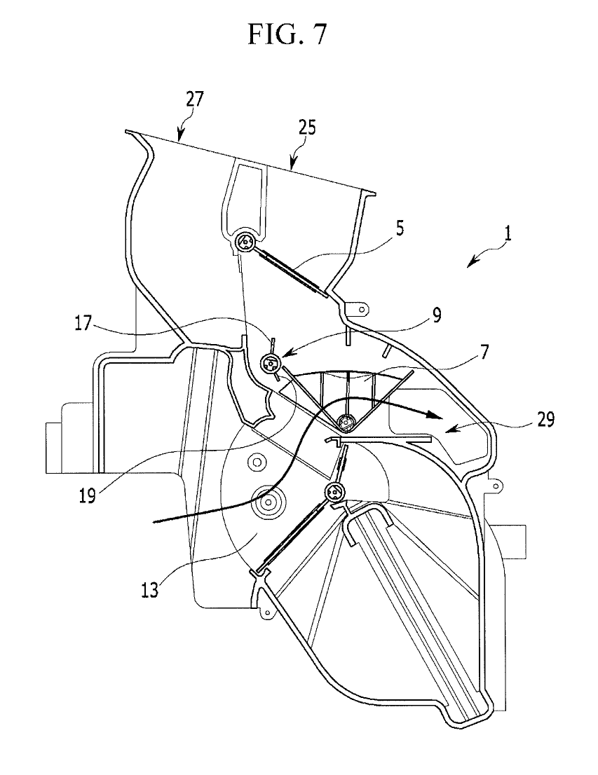

FIG. 7 is a state view of a floor mode of the air conditioner for a vehicle according to the exemplary embodiment of the present invention.

Referring to FIG. 7, for an operation in a floor mode, the floor door 7 is rotated toward the sub door 9 from a state of the defrost mode so as to open the floor outlet 29.

At the same time, the floor door 7 blocks air from being supplied to the vent outlet 25 and the defrost outlet 27.

Accordingly, air flowing into the air conditioning case 13 may be discharged to the interior room through the floor outlet 29.

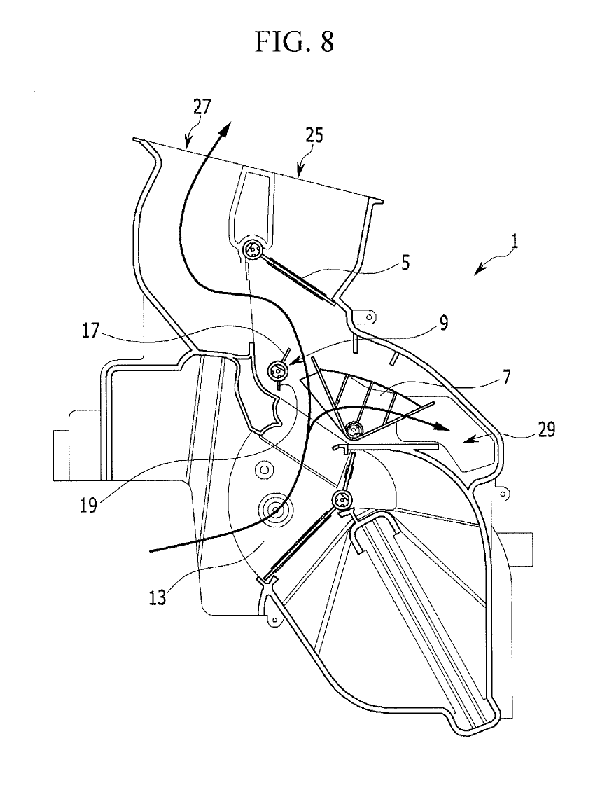

FIG. 8 is a state view of a mix mode of the air conditioner for a vehicle according to the exemplary embodiment of the present invention.

Referring to FIG. 8, for an operation in a mix mode, the floor door 7 is rotated toward the floor outlet 25 from a state of the floor mode, such that a part of air flows toward the vent outlet 25 and the defrost outlet 27.

In this case, a part of the floor outlet 29 is closed by the floor door 7, and the vent door 5 maintains a closed state of the vent outlet 25.

Accordingly, air flowing into the air conditioning case 13 may be discharged through the floor outlet 29 and the defrost outlet 27.

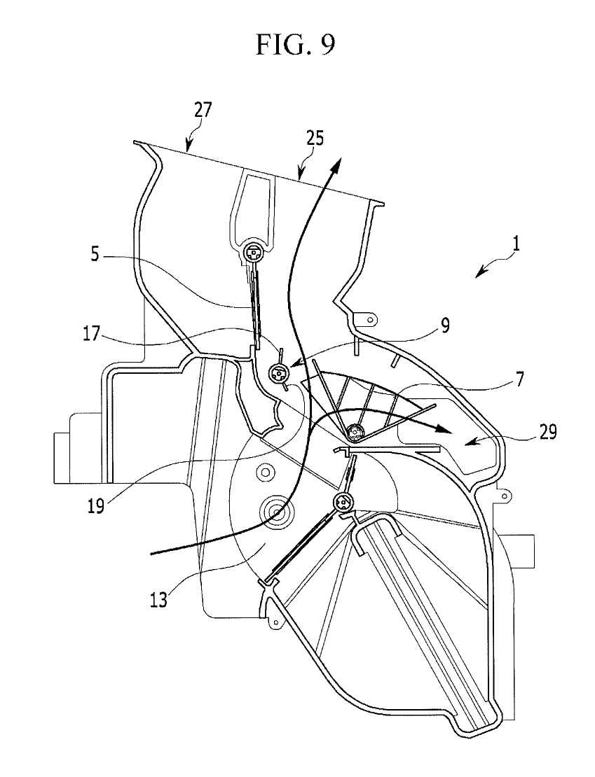

FIG. 9 is a state view of a bi-level mode of the air conditioner for a vehicle according to the exemplary embodiment of the present invention.

Referring to FIG. 9, for an operation in a bi-level mode, the vent door 5 is rotated toward the sub door 9 from a state of the mix mode so as to open the vent outlet 25, and simultaneously close the defrost outlet 27.

In this case, the floor door 7 maintains the mix mode state.

Accordingly, air flowing into the air conditioning case 13 may be discharged to the interior room via the lower vane 19 and the upper vane 17 of the sub door 9 through the vent outlet 25 and the floor outlet 29.

Meanwhile, in the operation modes, while the sub door 9 is minutely operated, the upper and lower vanes 17 and 19 affect a flow of air that flows into the air conditioning case 13.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. They are not intended to be exhaustive or to limit the invention to the precise forms disclosed, and obviously many modifications and variations are possible in light of the above teachings as well as various alternatives and modifications thereof. It is intended that the scope of the invention be defined by the Claims appended hereto and their equivalents.

What is claimed is:

1. An air conditioner for a vehicle, which has mode doors that are installed on an air conditioning case and have a vent door and a floor door that are connected to each other by a connecting link, and cools, heats, and ventilates an interior room through various operation modes,
wherein a sub door, which distributes supplied air while being rotated about a separate drive shaft, is installed between the vent door and the floor door.

2. The air conditioner of claim 1, wherein the drive shaft is rotatably connected to the connecting link, and the sub door is operated in conjunction with the vent door and the floor door.

3. The air conditioner of claim 2, wherein the sub door is rotated so as to correspond to an operation mode of the mode door.

4. The air conditioner of claim 3, wherein the sub door includes:
the drive shaft rotatably which is connected to the connecting link;
an upper vane which is provided on an outer circumferential surface of the drive shaft; and
a lower vane which is provided on an outer circumferential surface of the drive shaft and corresponds to the upper vane.

5. The air conditioner of claim 4, wherein the lower vane is formed to be inclined toward the floor door.

6. The air conditioner of claim 4, wherein the drive shaft is connected to a floor link which connects a cam of the connecting link with the floor door.

7. The air conditioner of claim 4, wherein when the lower vane is rotated, the lower vane partially overlaps a region within which the floor door is rotated.

8. An air conditioner for a vehicle, which has mode doors that are installed on an air conditioning case and have a vent door and a floor door that are connected to each other by a connecting link, and cools, heats, and ventilates an interior room through various operation modes, the air conditioner comprising:
a sub door which is installed between the vent door and the floor door, and distributes supplied air while being rotated about a drive shaft,
wherein the drive shaft is independently connected to the connecting link, and the sub door is operated in conjunction with the vent door and the floor door, and rotated at a predetermined angle while corresponding to an operation mode of the mode door.

9. The air conditioner of claim 8, wherein the sub door includes:
the drive shaft which is rotatably connected to the connecting link;
an upper vane which is provided on an outer circumferential surface of the drive shaft; and
a lower vane which is provided on an outer circumferential surface of the drive shaft and corresponds to the upper vane.

10. The air conditioner of claim 9, wherein the lower vane is formed to be inclined toward the floor door.

11. The air conditioner of claim 9, wherein the drive shaft is connected to a floor link which connects a cam of the connecting link with the floor door.

12. The air conditioner of claim 9, wherein when the lower vane is rotated, the lower vane partially overlaps a region within which the floor door is rotated.
